(19) United States
(12) Patent Application Publication
(10) Pub. No.: US 2007/0046129 A1
(43) Pub. Date: Mar. 1, 2007

(54) Stator for Motor, Recording Disc Driving Motor Using the Same for Recording Disc Driving Device

(75) Inventor: Shingo Suginobu, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/466,457

(22) Filed: Aug. 23, 2006

(30) Foreign Application Priority Data
Aug. 24, 2005 (JP) JP-2005-242753

(51) Int. Cl. H02K 7/00; G11B 17/08; G11B 17/04

(52) U.S. Cl. 310/216; 310/180; 310/67 R; 360/99.07; 360/98.07

(57) ABSTRACT

A stator of a motor comprises a core which has thereon a plurality of teeth and a core back, a coil which will be formed on each tooth, and a bridging wire connecting the coils. In the core which is formed of two core plates laminated to one another, a bridging wire latching section is provided between two adjacent teeth. A notched portion is provided at a portion, of the core plate, corresponding to the bridging wire latching section on the core plate which forms a top layer of the core. The bridging wire will be latched at a gap provided between the bridging wire latching section and the notched portion.

### BACKGROUND OF THE INVENTION

1. Technical Field

The present invention relates to a stator for a recording disc driving motor, to a recording disc driving motor, including therein the stator, and to a recording disc driving device.

2. Description of the Related Art

Conventionally, a recording disc driving device such as a hard disc drive includes a spindle motor (hereinafter, referred to simply as a motor) which rotates a recording disc. An inner rotor type motor having therein a rotor magnet inside a plurality of teeth, which are positioned in a radial manner around a shaft of the inner motor, may be used as such motor for rotating the disc.

In the inner rotor motor, a coil formed around each of the plurality of teeth is connected by a bridging wire at a ring shaped core back, arranged outside of the teeth, for supporting the teeth.

For example, when the motor is driven by three-phase currents, the bridging wire extending from one of the coils is to be connected to a third coil in a radial direction. In order to prevent the bridging wire which skips two coils between the connected coils, a protruding portion is provided on top of a resin made insulator attached to the core back so as to latch the bridging wire. Due to the protruding portion, the bridging wire is prevented from moving toward the inside of the core back.

However, when such insulator is used to latch the bridging wire, thickness of the stator core will be increased in an axial direction making it difficult to minimize a size of the motor. Also, the cost for parts and for manufacturing the motor will be increased since the number of parts required for the motor will be increased. Therefore, various techniques for latching the bridging wire by using the stator core have been proposed.

Since electric space for providing therein a stator is limited in a motor having a reduced thickness, it is difficult to provide enough height for a bridging wire latching section to be formed on the stator.

For example, a tip portion, of the bridging wire latching section, which is bent upward, will be positioned above a surface of the core back. Then the tip portion of the bridging wire latching section will be positioned above a wire winding height of the coil. This will increase the height of the stator. When the height of the stator is increased, the thickness of the stator core will need to be reduced making it difficult to apply such stator core to the motor having the reduced thickness.

### BRIEF SUMMARY OF THE INVENTION

A stator according to the present invention for a motor used for driving a recording disc includes a plurality of teeth and a core having a ring shaped core back. The plural teeth are arranged in a radial manner with the center thereof being a center axis. The core back supports the plurality of teeth along an outer side of the plurality of teeth. The plurality of teeth each are wound by wires so as to form a plurality of coils.

The core includes, at least, a thin plate shaped second core plate and a first core plate which is positioned axially above the second core plate.

The second core plate includes a bridging wire latching section. The bridging wire latching section is positioned radially inside the core back between two adjacent teeth. The bridging wire latching section is bent and protrudes toward the first core plate.

A gap is provided between a radially outward facing surface of the bridging wire latching section and an inner periphery of the core back between two adjacent teeth. At least a portion of a plurality of bridging wires connecting between two teeth will be latched inside the gap.

According to the stator of the present invention, height of a portion, of the bridging wire latching section, protruding out of the core will be reduced. Or such protruding portion will be eliminated. By this, the thickness of the motor will be reduced.

Further, a portion, of the bridging wire latching section, protruding toward the center axis can be reduced such that a needle of a wire winding machine will be allowed to move in a large area.

Note that in the description of the preferred embodiments of the present invention herein, words such as upper, lower, left, right, upward, downward, top and bottom for describing positional relationships between respective members and directions merely indicate positional relationships and direction in the drawings. Such words do not indicate positional relationships and directions of the members mounted in an actual device.

### BRIEF DESCRIPTION OF THE SEVERAL VIEWS OF THE DRAWINGS

FIG. 1 is a diagram illustrating an internal configuration of a recording disc driving device according to a first embodiment of the present invention.

FIG. 2 is a longitudinal sectional view of a motor illustrated in FIG. 1.

FIG. 3 is a plan view of a core according to an embodiment of the present invention.

FIG. 4A is an enlarged view of a bridging wire latching section.

FIG. 4B is a diagram illustrating a cross section of the bridging wire latching section as viewed from a position A-A illustrated in FIG. 4A.

FIG. 5 is a plan view of a second core plate.

FIG. 6 is a plan view of a first core plate.

FIG. 7 is a plan view of a stator during a manufacture process thereof.

FIG. 8 is a longitudinal sectional view of a motor according to a second embodiment of the present invention.

FIG. 9 is a plan view of a core according to the second embodiment of the present invention.

FIG. 10A is an enlarged view of the bridging wire latching section.

FIG. 10B is a diagram illustrating a cross section of the bridging wire latching section.

FIG. 11A is an enlarged view of the bridging wire latching section.

FIG. 11B is a diagram illustrating a cross section of the bridging wire latching section.

FIG. 12A is an enlarged view of the bridging wire latching section.

FIG. 12B is a diagram illustrating a cross section of the bridging wire latching section.

FIG. 13 is a diagram illustrating a cross section of the motor.

FIG. 14 is an enlarged view of a section of the core.

FIG. 15 is a plan view of the core.

FIG. 16 is a diagram illustrating a cross section of the bridging wire latching section.

### DETAILED DESCRIPTION OF THE INVENTION

Hereinafter, an embodiment of the present invention will be described. In the description of the embodiments of the present invention herein, words such as upper, lower, left, right, upward, downward, top and bottom for describing positional relationships between respective members and directions merely indicate positional relationships and direction in the drawings. Such words do not indicate positional relationships and directions of the members mounted in an actual device.

### FIRST EMBODIMENT

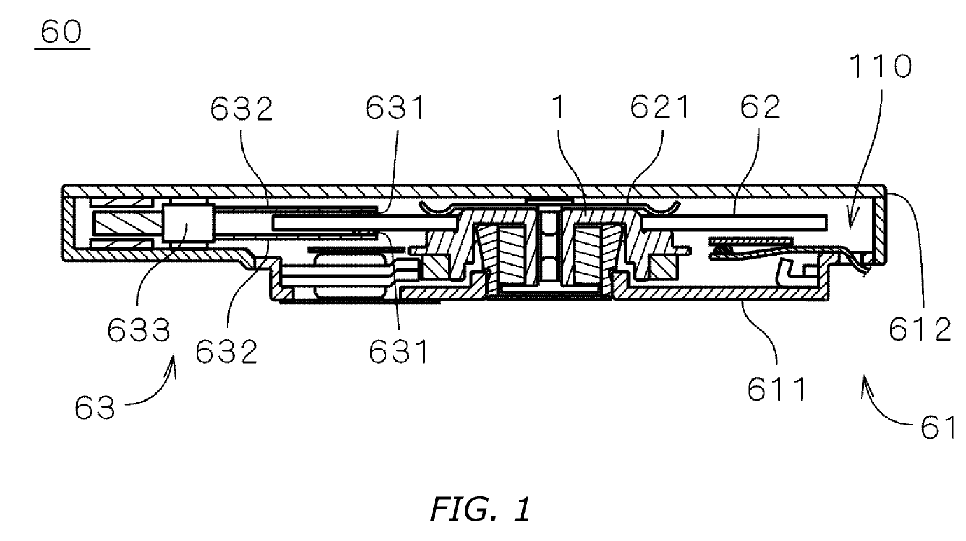

FIG. 1 is a diagram illustrating an internal configuration of a recording disc driving device 60 having installed thereon an electric spindle motor 1 (hereinafter, referred to as a “motor 1”) according to an first embodiment of the present invention. A recording disc driving device 60 is a hard disc device comprising: a recording disc 62 for recording therein data; an access portion 63 for writing and/or reading data; an electric motor 1 for retaining and rotating the recording disc 62; and a housing 61 for housing in an inside space 110 thereof the recording disc 62, the access portion 63, and the motor 1.

As illustrated in FIG. 1, the housing 61 includes a first housing member 611 which is an inoperculate box shape having an upper opening, to the inner bottom surface of which the motor 1 and the access portion 63 are attached, and a second housing member 612 which is a sheet shaped member occluding the upper opening of the first housing member 611 so as to define the inside space 110 which is a clean chamber allowing therein an extremely small amount of dust.

The recording disc 62 is placed onto an upper portion of the motor 1 and is affixed by a damper 621. The access portion 63 includes a head 631 which adjoins the recording disc 62 and magnetically reads data from and writes data on the recording disc 62, an arm 632 which supports the head 631, and a head locating member 633 which moves the arm 632 so as to move the head 631 relative to the recording disc 62 and the motor 1. By virtue of the configuration described above, the head 631 may access the specific position adjoining the rotating recording disc 62 and may read data from and write data on the recording disc 62 with the head 631 adjoining to the recording disc 62.

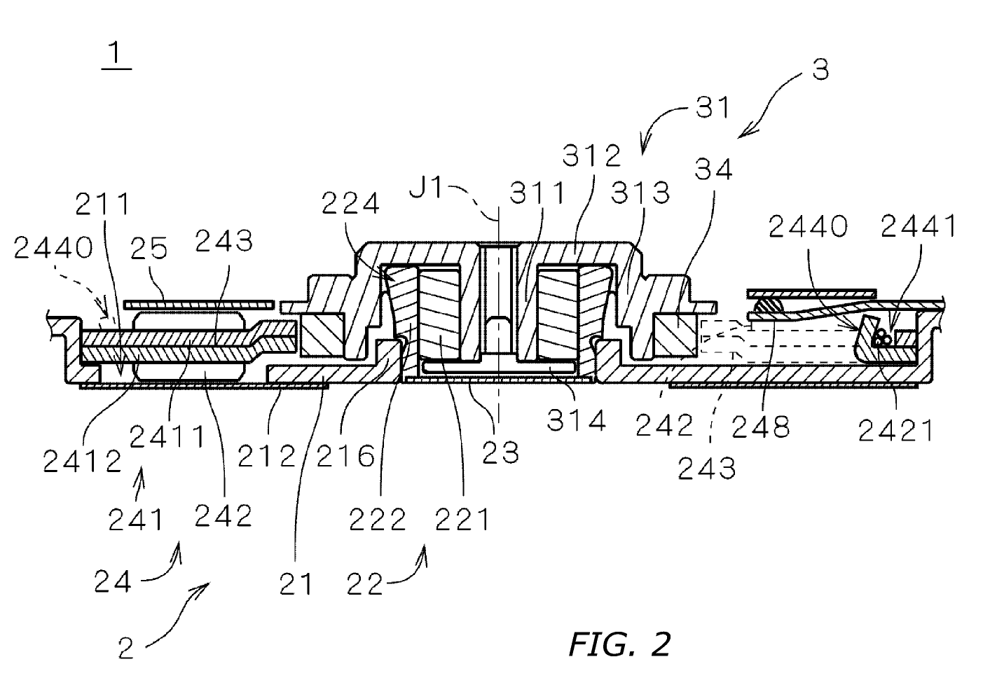

FIG. 2 is a longitudinal sectional view of the motor 1 (see FIG. 1) used for rotating the recording disc 62. The motor 1 is driven by three-phase currents. While a section in the plane which contains a center axis J1 (which is a center axis of a stator 24 described below) is illustrated in FIG. 2, a portion of the configuration positioned deeper than the plane of the section is also depicted by broken lines.

As illustrated in FIG. 2, the motor 1 includes a stationary portion 2 and a rotor section 3. The rotor section 3 is rotatably supported via a bearing mechanism employing hydrodynamic pressure of lubricant oil.

The rotor unit 3 includes a rotor hub 31 which retains the different parts of the rotor unit 3 and a rotor magnet 34 which is attached to the rotor hub 31 and is circumferentially arranged around the center axis J1. The rotor hub 31 may be made of any suitable materials, such as stainless steel, and integrally includes: a shaft 311 which is substantially cylindrical shape centering on the center axis J1 and extends downwardly; a plate section 312 which is discoid shaped and expanding perpendicularly with respect to the center axis J1 from an upper end portion of the shaft 311; and a cylindrical section 313 which has a substantially cylindrical shape and extends downwardly at a rim of the circular plate section 312. A thrust plate 314 which is substantially discoid shape is attached to a lower end portion of the shaft 311.

The stationary portion 2 includes a base plate 21 retaining the various parts of the stationary portion 2 and a sleeve unit 22 having a substantially cylindrical shape and being a part of the bearing mechanism into which the shaft 311 is inserted so as to support the rotor 3. The stationary portion 2 further includes a stator 24 attached to the base plate 21 at a portion around the sleeve unit 22 and a magnetic shield 25 which is a sheet shaped member arranged over the stator 24 and shields magnetic noise radiated from the stator 24.

The base plate 21 is a portion of the first housing member 611 (see FIG. 1 ) and is formed unitarily with the rest of the first housing member 611 by pressing sheet materials made of an aluminum, aluminum-alloy, or magnetic or non-magnetic ferrous-metal. The stator 24 generates a torque centering on the center axis J1 between itself and the rotor magnet 24 arranged around the shaft 311.

The stator 24 is attached along the upper side of the base plate 21 by press-fitting or adhesives, and includes a core 241 formed by laminating, in this embodiment, two core plates made of silicon steel plates. The stator 24 further includes a plurality of coils (a first coil 242a and a second coil 242b described later) formed in predetermined positions on the core 241.

Thickness of each core plate forming the core 241 is from about 0.1 mm to about 0.35 mm, more preferably about 0.2 mm. The stator 24 of the motor 1 is appropriately structured for the motor having the reduced thickness and dimensions, more particularly for the motor formed of two core plates 241, or the motor formed of a core plate having thickness less than 0.5 mm. In order to distinguish one core plate over the other, the core plate on a top layer will be referred to as a “first core plate 2411,” and the core plate on a bottom layer will be referred to as a “second core plate 2412.” Note that in FIG. 2 and other figures illustrating the core plates the thickness of the core plates is depict enlarged.

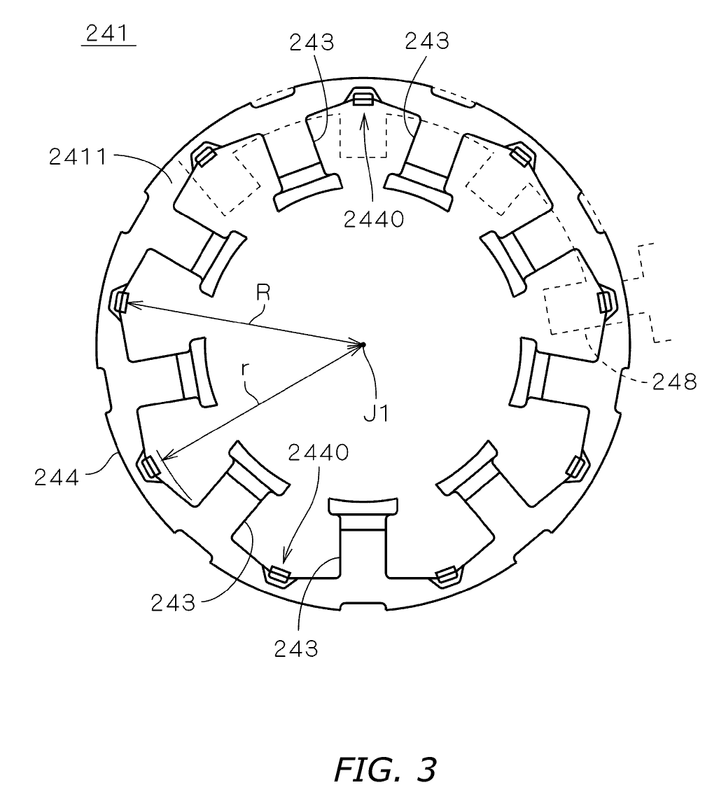

FIG. 3 is a plan view of the core 241. As illustrated in FIG. 3, the core 241 includes a plurality of teeth (nine teeth in this embodiment). The teeth are radially arranged with the center axis J1 as the center, and their tip portions extend in a radial direction toward the center axis J1. The core 241 includes a core back 244 which is a ring shaped member supporting the plurality of teeth 243 along the outer side of the teeth.

The first core plate 2411 and the second core plate 2412, each having therein portions corresponding to the plurality of teeth 243 and the core back 244, are laminated (see FIG. 2) so as to provide the plurality of teeth 243 and the core back 244. Since each core plate is integrally provided with portions corresponding to the plurality of teeth 243 and the core back 244, the plurality of teeth 243 and the core back 244 are magnetically connected to the core 241.

As illustrated in FIG. 2, nine coils 242 are formed by winding the wire around each of the nine teeth 243 of the core 241. The nine coils 242 each are formed by winding the wire around each tooth so as to form two layers of the wire, wherein a diameter of the wire is between 0.05 mm to 0.3 mm (preferably, 0.1 mm).

As stated above, a driving current of the motor 1 is the three-phase currents, therefore, in the stator 24, the nine coils 242 are divided into three units of the coils 242 each comprised of three coils 242, wherein three coils 242 in each unit are connected to one another by a bridging wire 2421.

Further, in the motor 1, an end portion of each of the tooth 243 is bent upward so as to face a periphery of the rotor magnet 34, thereby effectively generating a torque between the stator 24 and the rotor magnet 34.

As shown in FIG. 2, a sleeve attachment portion 216 is formed at a central portion of the base plate 21. The sleeve attachment portion 216 has a substantially cylindrical shape and upwardly protrudes from the base plate 21 with centering on the center axis J1. As shown in FIG. 2, the sleeve unit 22 includes a sleeve 221 having a substantially cylindrical shape, into which the shaft 311 is inserted, and a sleeve housing 222 having a substantially cylindrical shape which is attached to an outer circumference of the sleeve 221 by adhesives. The sleeve unit 22 is inserted into the sleeve-attachment portion 216 to attach it to the base plate 21.

The sleeve 221 is inserted into the sleeve housing 222 with a gap maintained between the sleeve 221 and an inner circumferential surface of the sleeve housing 222 (i.e., the sleeve is inserted at a clearance fit), and is affixed to the sleeve housing 222 via an adhesive. The sleeve 221 is a porous member, formed by pressure-molding, by putting a powdered starting material into a mold and by press-hardening the material, and then by sintering the compact and putting the sintered compact again into a mold to compress it into final form. Various kinds of metal powders, powders of metallic compounds, powders of non-metallic compounds, etc. may be used as the starting material for forming the sleeve 221 (for example: a blend of iron (Fe) and copper (Cu) powders; a blend of copper and tin (Sn) powders; a blend of copper, tin and lead (Pb) powders; or a blend of iron and carbon (C) powders).

A flange portion 224 of the sleeve housing 222 is unitarily formed along the outer circumference of the sleeve unit 22 at the upper portion of the sleeve housing 222. The flange portion 224 bulges outwardly with respect to the center axis J1. The opening along a lower end of the sleeve unit 22 is occluded by a sealing cap 23 having a substantially discoid shape. Therefore, the opening of the base plate 21 along a lower side of the sleeve attachment portion 216 is occluded by the sleeve housing 222 and the sealing cap 23.

A plurality (nine in the present embodiment) of through-hole portions 211 which penetrate the base plate 21 are provided at an area, on the base plate 21, corresponding to the plurality of teeth 243 surrounding the sleeve attachment portion 216. With the stator 24 being attached to the base plate 21, a lower side of each coil 242 are accommodated into corresponding through-hole portions 211 of the base plate 21 without downwardly protruding from the lower surface of the base plate 21. Therefore, the thickness of the motor 1 may be reduced without overly reducing the thickness of the base plate 21.

In the stationary portion 2, the through-hole portion 211 into which the coil 242 is to be inserted is filled with adhesive, whereby the coil 242 is affixed to the base plate 21 and the through-hole portion 211 will be sealed. Also, the base plate 21 includes a sealing member 212 having a sheet shape (such as a flexible circuit board and a name plate). The sealing member 212 occludes the through-hole portions 211 along a lower side of the side on which the stator 24 is attached. The seal portion 212 is attached to the lower main surface of the base plate 21 via an adhesive layer or a glue layer.

The bearing mechanism, which utilizes hydrodynamic pressure to rotatably support the rotor unit 3 relative to the stator unit 2 in the motor 1 will be described below. As illustrated in FIG. 2, gaps are provided at the following portions of the motor 1, the portions include: between the lower surface of the circular plate section 312 of the rotor hub 31 and the upper end surface of the sleeve housing 222; between the inner circumferential surface of the sleeve 221 and the outer circumferential surface of the shaft 311; between the lower end surface of the sleeve 221 and the upper surface of the thrust plate 314; between the lower surface of the thrust plate 314 and the upper surface of the sealing cap 23; and between outer circumferential surface of the flange portion 224 of the sleeve housing 222 and the inner circumferential surface of the cylindrical section 313 of the rotor hub 31. These gaps are continuously and consistently filled with lubricant oil.

An inclined surface is provided on the outer circumferential surface of the flange portion 224 of the sleeve housing 222, where the housing gradually constricts in outer diameter heading downward, while the cylindrical section 313 of the rotor hub 31 is formed so that the inner circumferential surface thereof, which opposes the outer-side surface of the flange portion 224, is of constant diameter. With this configuration, the boundary surface of the lubricating oil and air at a gap maintained between the flange portion 224 and the cylindrical portion 313 forms a meniscus shape under the capillary action and surface tension, constituting a taper seal, whereby the gap functions as an oil buffer, preventing outflow of the lubricating oil.

On the upper end surface of the sleeve housing 222 and the lower end surface of the sleeve 221, grooves (for example, grooves in a spiral shape) for inducing the dynamic pressure in the lubricant oil directed toward the center axis J1 are provided. With the aforementioned end surfaces and the surfaces facing thereto, a thrust dynamic bearing section is defined.

Meanwhile, grooves (for example, herringbone grooves provided on the inner circumferential surface of the sleeve 221 in an axially spaced manner) for inducing hydrodynamic pressure in the lubricating oil are formed on the surfaces of the shaft 311 and the sleeve 221 facing each other. With the surfaces facing each other, a radial dynamic bearing section is defined.

In the motor 1, since the rotor unit 3 is supported in a non-contact manner via the lubricating oil by the hydrodynamic pressure employing bearing mechanism, the rotor unit 3 is allowed to rotate with high precision and low noise. In particular, abnormal contact between the shaft 311 and the sleeve 221 caused by air bubbles produced within the lubricating oil, lubricating oil leakage and similar problems due to the swelling of bearing-internal air may be all but eliminated. Moreover, since the sleeve 221 is a porous component pressured-molded from a powdered starting material, the lubricating oil is powerfully retained in the bearing mechanism, and particles and other impurities within the lubricating oil are absorbed, thereby keeping the lubricating oil clean.

As described above, in the motor 1, the gaps formed in between sleeve unit 22 (i.e., the sleeve 221 and the sleeve housing 222), the rotor hub 31, and the sealing cap 23 are filled with the fluid lubricating oil. Thus when the rotor unit 3 rotates, hydrodynamic pressure is induced to support the rotor unit 3 via the lubricating oil. When the rotor portion 3 rotates with the center axis J1 as center, the recording disc 62 (see FIG. 1) which is attached to the rotor portion 3 is rotary driven.

Subsequently, a configuration of the core 241 illustrated in FIG. 3 will be described. As illustrated in FIG. 3, a bridging wire latching section 2440 for latching the bridging wire 2421 (see FIG. 2) is provided between teeth 243, which are next to one another, on the core back 244 of the core 241. The bridging wire 2421 is a portion, of the wire, connecting between adjacent coils 242, or between one of the coils 242 and a circuit board 248.

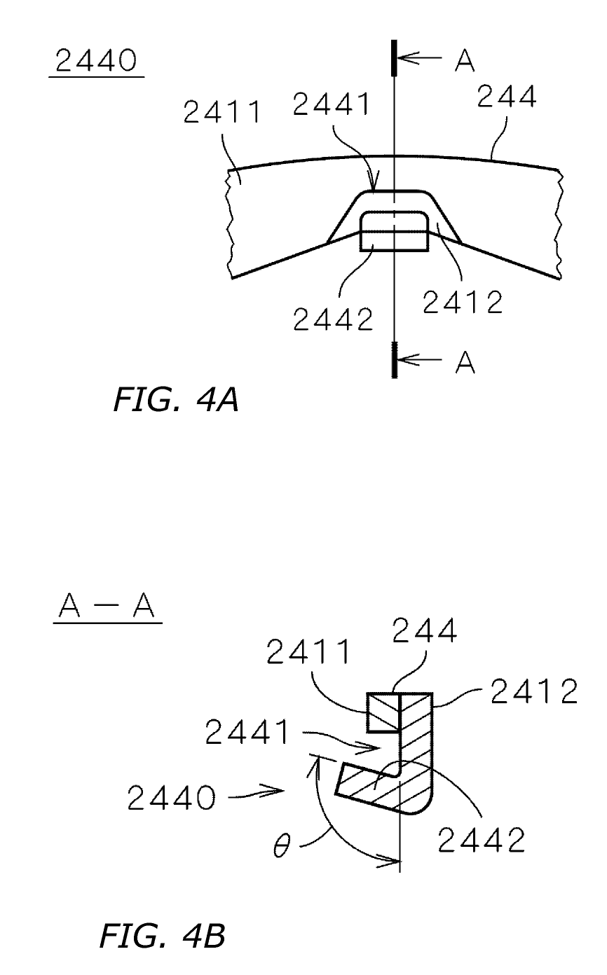

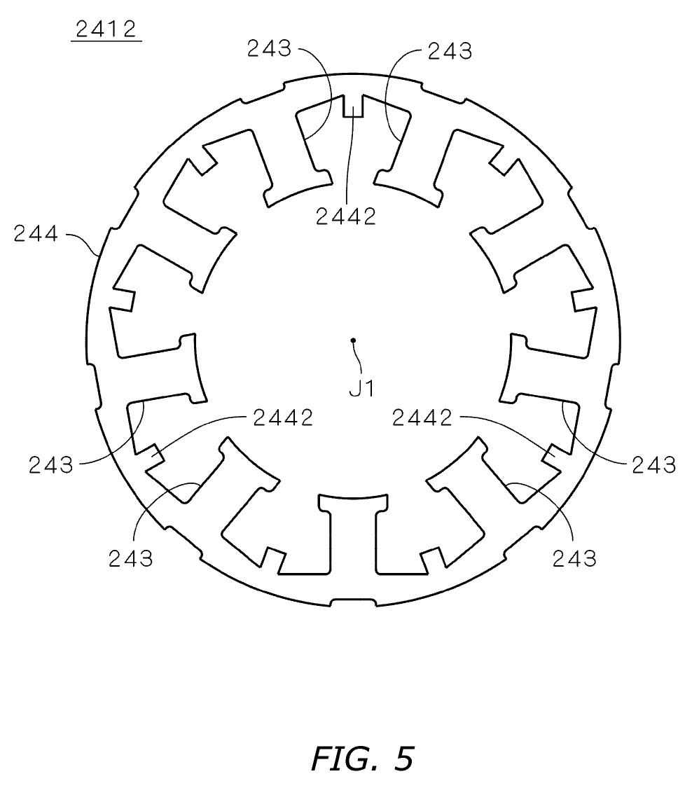

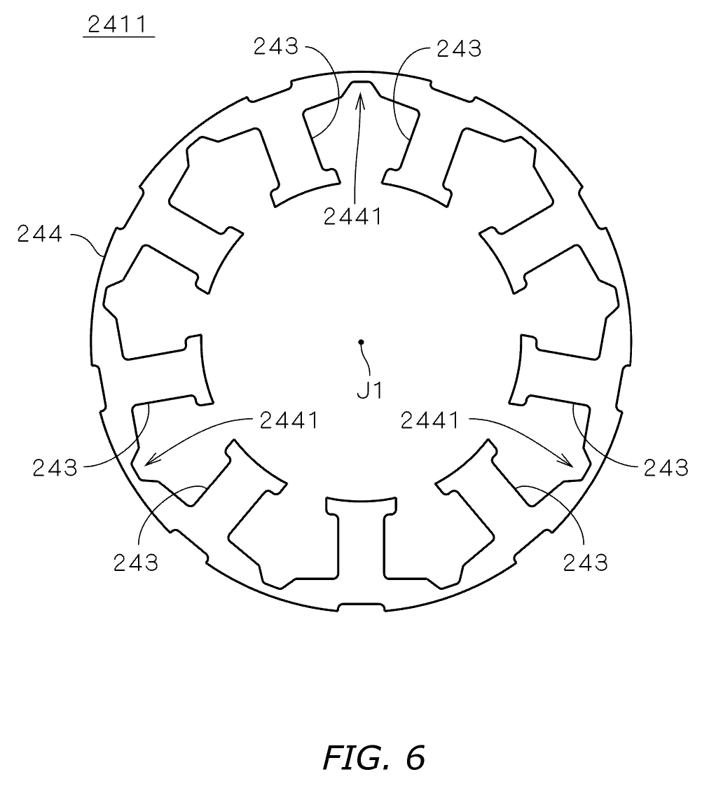

In FIG. 3, the circuit board is depicted by broken lines. FIG. 4A is a diagram illustrating an enlarged plan view of the bridging wire latching section 2440, and FIG. 4B is a diagram illustrating a cross section of the bridging wire latching section 2440 as viewed from a position A-A illustrated in FIG. 4A. Also, FIG. 5 is a plan view of the second core plate 2412 made of silicon steel plate, and FIG. 6 is a plan view illustrating the silicon steel plate 2411 made of silicon steel plate.

As illustrated in FIG. 5, in the second core plate 2412, a protruding portion 2442 protruding toward the center axis J1 is provided at an inner periphery of a portion corresponding to the core back 2442 (hereinafter, referred to as a core back 244) between adjacent teeth 243.

As illustrated in FIG. 4B, the protruding portions 2442 are bent toward the inner periphery of the core back 244, thereby forming the bridging wire latching section 2440 as illustrated in FIGS. 4A and 4B. Preferably, an angle generated by the protruding portion 2442 and an upper main surface of the second core plate 2412 is greater than 90°.

As illustrated in FIG. 2, the bridging wire latching section 2440 is bent upward and is parallel to the center axis J1. Also, the bridging wire latching section 2440 may be bent toward the center axis J1 if the bridging wire latching section 2440 is able to latch the bridging wire 2421. That is, since the protruding portion 2442 is bent upward of the core 241, the bridging wire latching section 2440 which protrudes in an upward direction is provided.

Further, as illustrated in FIG. 3, an R, which is a distance between a surface, of the bridging wire latching section 2440, making contact with the bridging wire and the center axis J1, is preferably greater than an r, which is a distance between a base of the tooth 243 and the center axis J1.

As illustrated in FIG. 6, in the first core plate 2441, a plurality of notched portions 2441 are provided on the inner periphery, of the core back 244, at a space between two adjacent teeth 243. That is, the plurality of notched portions 2441 are provided at positions corresponding to the protruding portions 2442.

As illustrated in FIGS. 4A and 4B, a gap is provided between a surface, of the bridging wire latching section 2440, facing the inner periphery of the core back 244 and the notched portion 244 so as to latch therein the bridging wire 2421 connecting two teeth 243 which are next to one another. When the bridging wire does not fit due to a number or a diameter of the bridging wire 2421 exceeds a capacity of the bridging wire latching section 2440.

In the stator 24, as illustrated in FIGS. 2 or 4B, the core 241 is formed by two core plates, while the bridging wire latching section 2440 is provided on only the second core plate 2412 which is a lower core plate of two core plates. The core plate 2412 having formed thereon the bridging wire latching section 2440 makes a contact with the first core plate 2411.

When the core is formed by using three core plates, the bridging wire latching section 2440 is to be provided on one of two core plates forming a lower portion of the core. The notched portions 2441 are to be provided on the core plates which do not form thereon the bridging wire latching sections 2440. The notched portions 2441 are provided so that the bridging wire latching sections are contained therein.

The protruding portion 2442 of the second core plate 2412 are to be bent forming the bridging wire latching section 2440 even when the notched portions 2441 are not provided on the first core plate 2411. When such bridging wire latching sections 2440 are formed, the bridging wire is to be latched in the gap generated by the surface, of the bridging wire latching section 2440, facing the center axis J1, and a portion of the inner surface, of the core back 244, corresponding to a portion between two adjacent teeth 243.

Subsequently, methods of manufacturing the stator 24 and attaching the stator 24 to the base plate 32 will be described. Firstly, in order to manufacture the stator 24, the core plate is formed by piercing the silicon steel plate (or other electromagnetic steel plate) into a shape of the first core plate 2411 or the second core plate 2412 as illustrated in FIGS. 6 and 5. While the first core plate 2411 is being formed, the notched portion 2441 (see FIG. 6) is formed on the first core plate 2411 at the portion on the inner circumferential surface thereof between each tooth 243. While the second core plate 2412 is being formed, the protruding portion 2442 (see FIG. 5) is formed on the second core plate at the portion thereof between each tooth 243.

Subsequently, portions, of each core plate, corresponding to the plurality of teeth 243 are press-worked so as to be bent slightly upward, wherein only the ends of such portions, nearest to the center axis J1, are bent. Then the two core plates are laminated and fixed by a fixing method such as calking or laser welding. Then, on the surface of the laminated core plate, nonconductive resin is painted by a method such as electrode position process or powder coating so as to form the core 241.

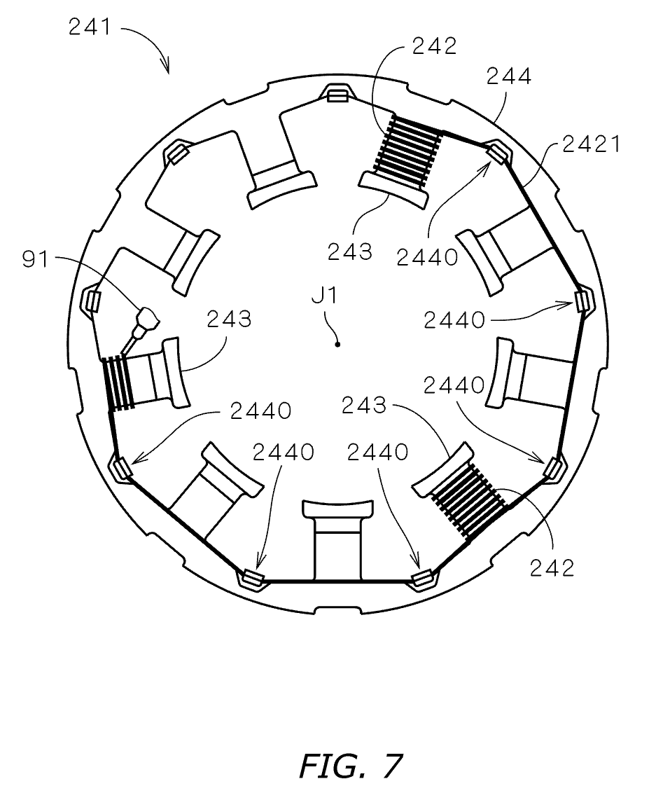

FIG. 7 is a plan view of the stator 24 during a manufacture process thereof. Once the core 241 is formed, a wire winding machine 91 as illustrated in FIG. 7 (only a needle of the wire winding machine 91 is illustrated) winds the wire forming two layers thereof around each tooth 243 so as to form the coil 242. The coil is wound, around the tooth 243, starting from an area of the tooth 243 furthest from the center axis J1 and continuing toward the center axis J1, and then, back toward the area furthest from the center axis J1.

When the first coil 242 is completed, the wire (the bridging wire 2421) is led in a clockwise direction from the coil 242 to the nearest bridging wire latching section 2440 in order for the bridging wire 2421 to be latched.

The bridging wire 2421 is to be latched at two successive bridging wire latching sections 2440 in the clockwise direction, and is to be led to a third tooth 243 from the first coil 242. Then, a second coil 242 is formed around the third tooth 243 after the wire is wound around it.

As described above, the bridging wire 2421 extending from the first coil 242 is to be latched at, in total, three bridging wire latching sections 2440, bypasses around an exterior of two teeth 243, and is led to the second coil 242. In other words, the bridging wire 2421 is to be latched at three bridging wire latching sections 2440 between the first coil 242 and the second coil 242. By this, the bridging wire 2421 between two coils will not interfere with other wires which will be wound around and connecting other teeth 243.

When the second coil is completed, the bridging wire 2421 extending from the second coil is to be latched at three successive bridging wire latching sections 2440, and is to be led to a third tooth in the clockwise direction from the second coil so as to form a third coil 242. The bridging wire 2421 extending from the third coil 242 will be, if necessary, latched at the nearest bridging wire latching section 2440 in the clockwise direction, led to the circuit board 248 (see FIG. 3), and soldered to an electrode on the circuit board 248.

Further, of the six teeth 243 which have not formed thereon the coils 242, three teeth 243 which are apart from one another by three teeth (including one tooth on which the coils 242 has been formed) will have formed thereon the coils 242 in an order as described above. Then, such coils 242 will be connected to the circuit board 248. Remaining teeth 243 which have not formed thereon the coil 242 will have formed thereon the coil 242 in the same order as described above. Then such coils 242 will be connected to the circuit board 248, thereby finishing the manufacturing of the stator 24.

Further, as illustrated in FIG. 2, the stator 24 will be affixed to the base plate 21 while an outer circumferential surface of the core back 244 being abutted against the base plate 21. The stator 24 may be affixed to the base plate 21 by press-fitting or by using adhesives applied to the portion of the base plate 21 against which the core back 244 is abutted.

The motor 1 and the recording disc driving device 60 have been described with respect to the configuration and manufacturing process thereof. In the stator 24, the bridging wire 2421 is latched in the space generated between the surface, of the bridging wire latching section 2440, facing the center axis J1 and the inner surface, of the core back, corresponding to the space between two adjacent teeth 243. By this, height, of the bridging wire latching section 2440, protruding from the core 241 is kept to minimum or kept within the core 241. Such configuration as described above allows the thickness of the motor to be reduced.

More particularly, in the stator 24, the bridging wire latching section 2440 is provided between each tooth 243, and therefore, portions of the bridging wire latching sections 2440 protruding out of an entire surface of the core 241 are kept to minimum or kept within the core 241. By virtue of the configuration described above, the stator 24 will have a reduced thickness while allowing the increased number of core plates.

Further, in the stator 24, the second core plate 2412 has formed thereon the bridging wire latching section 2440, and the first core plate 2411, which is position above the second core plate 2412, has formed thereon the notched portion 2441. Therefore, compared with a conventional stator, the stator 24 of the present invention can reduce its thickness as much as the thickness of the core plate having formed thereon the notched portion 2441. Also, since the height of the bridging wire latching section 2440 in the axial direction of the present invention can be reduced as much as the thickness of the core plate having formed thereon the notched portion 2441, the wire winding machine 91 will be allowed with a greater moving range. Note that when more than two core plates are used, core plates laminated above the core plate having formed thereon the bridging wire latching section 2440 have formed thereon the notched portions.

As illustrated in FIG. 3, the distance R, which is a distance between the bridging wire latching section 2440 and the center axis J1, is greater than the distance r, which is a distance between the base of the tooth 243 and the center axis J1. Therefore, the bridging wire latching section 2440 will not protrude toward the center axis J1 and the needle of wire winding machine 91 will be allowed with the greater moving range.

### SECOND EMBODIMENT

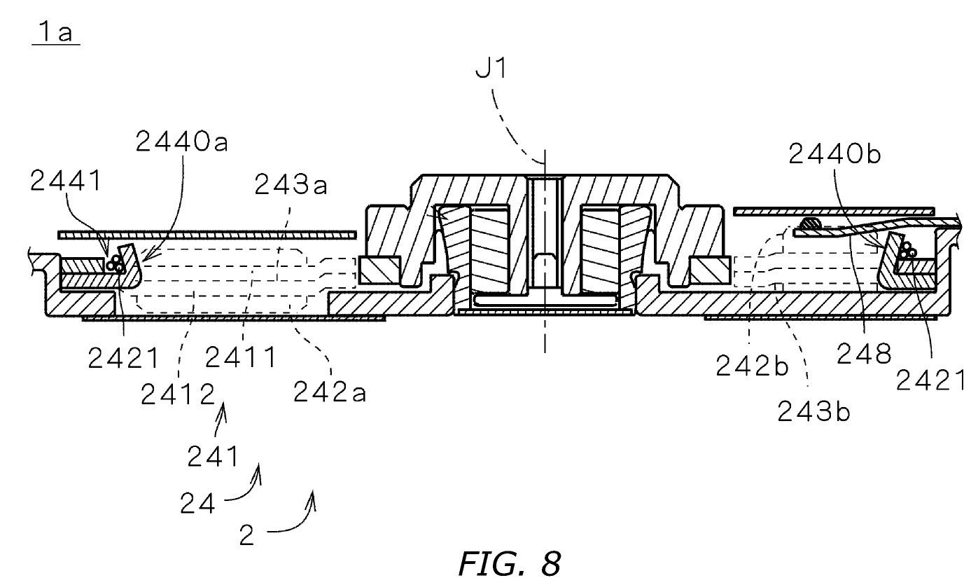

Hereinafter, a motor 1 a according to a second embodiment of the present invention will be described. FIG. 8 is a longitudinal sectional view of the motor la according to the second embodiment of the present invention. The motor 1 a is used for rotating the recording disc 62 (see FIG. 1) in a same manner as the motor 1, and has a same configuration as the motor 1 as illustrated in FIG. 2. It is, however, to be appreciated that the stator 24 of the motor 1 a has a different configuration from that of the motor 1, and that in description of the motor 1 a, elements similar to those used to describe the motor 1 are denoted by similar reference numerals and description thereof are omitted.

A core 241 of the stator 24 of the present embodiment has the same configuration as the motor 1 which includes two core plates (e.g., first core plate 2411 and second core plate 2412) as illustrated in FIG. 2.

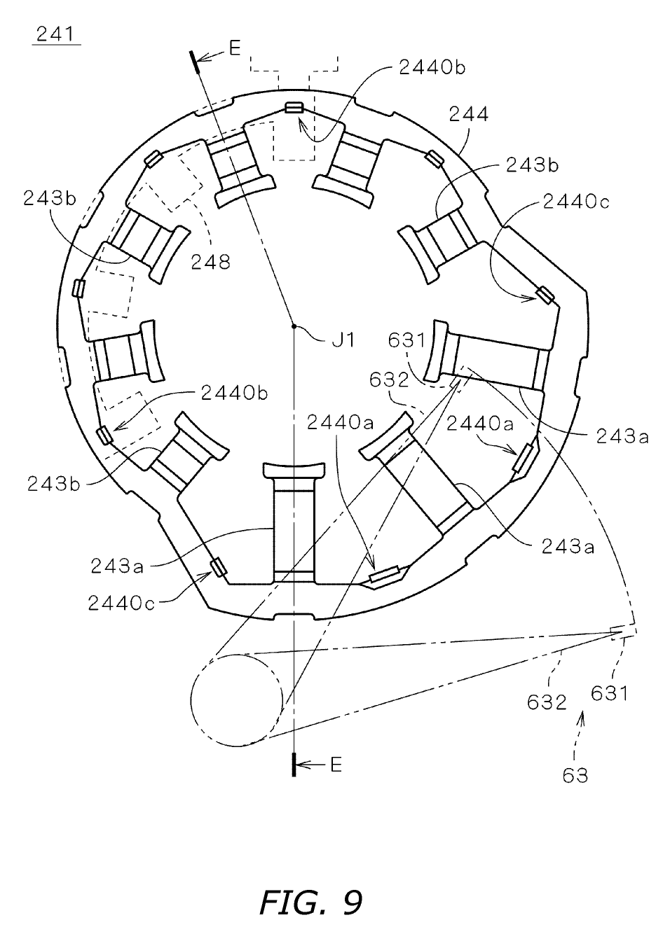

FIG. 9 is a plan view of the core 241 according to the second embodiment of the present invention. In FIG. 9, the circuit board 248 is depicted by broken lines while a head 631 and an arm 632 of an access portion 63 and their moving ranges are depicted by chain double-dash lines. As illustrated in FIG. 1, the head 631 and the arm 632 are to be a head portion which reads data from the recording disc and writes data on the recording disc.

The core 241 illustrated in FIG. 9 includes a plurality (nine in this embodiment) of teeth. The plural teeth are radially arranged with the center axis J1 as the center thereof, and their tip portions extend in the radial direction toward the center axis J1. Of the nine teeth included in the core 241, three teeth (teeth 243a) over which the head portion moves are radially longer than other six teeth (teeth 243b). In order to distinguish those three teeth 243a from the other teeth 243b, the former will be referred to as “first teeth,” while the other teeth will be referred to as “second teeth.” Also, the core 241 includes, in a same manner as the core 241 illustrated in FIG. 3, the ring shaped core back 244 for supporting the first teeth 243a and the second teeth 243b.

As illustrated in FIG. 8, in the stator 24, a wire is to be wound around each tooth of the first teeth 243a and the second teeth 243b so as to form thereon the coil. In total, nine coils are to be formed. Hereinafter, the coil to be formed on each tooth of the first teeth 243a will be referred to as a “first coil 243a” and the coil to be formed on each tooth of the second teeth will be referred to as a “second coil 243b.” The wire extending from each coil will be, as illustrated in FIGS. 8 and 9, led to the circuit board 248 via bridging wire latching sections 2440a, 2440b and 2440c provided between teeth 243, and then soldered to electrodes of the circuit board 248.

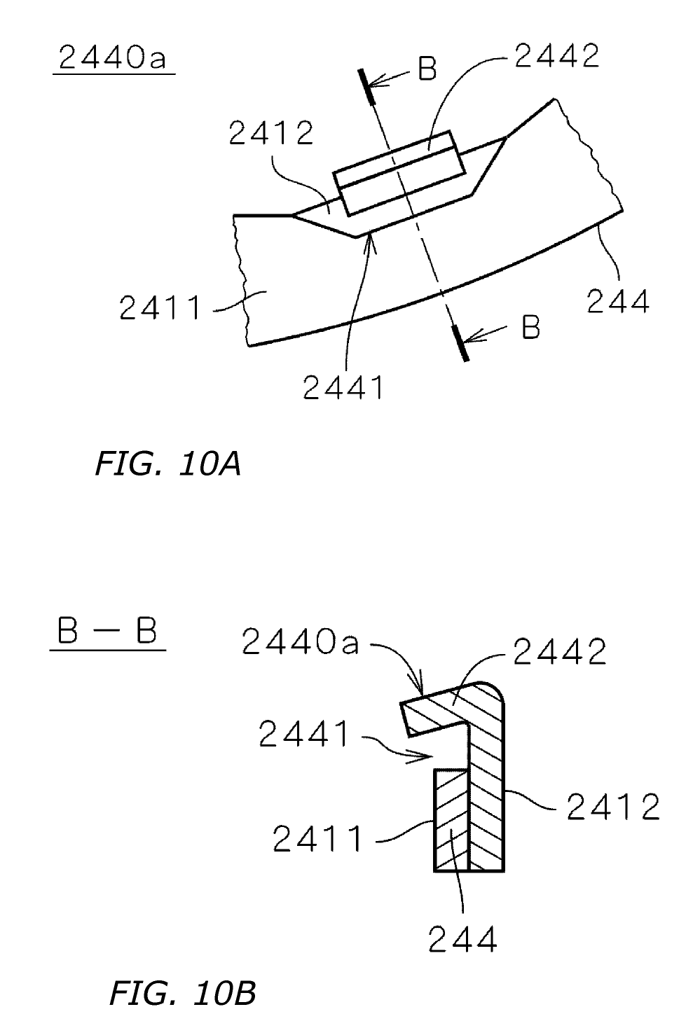

FIG. 10A is an enlarged view of the bridging wire latching section 2440a. FIG. 10B is a diagram illustrating a cross section of the bridging wire latching section 2440a as viewed from a point B-B illustrated in FIG. 10A.

The bridging wire latching section 2440a is provided between two adjacent teeth 243a of the first teeth 243a as illustrated in FIGS. 9 and 10B. In a same manner as the bridging wire latching section 2440 illustrated in FIG. 3, protruding portion 2442 of the second core plate 2412 are bent toward the inner periphery of the core back 244.

The first core plate 2411 includes a notched portion 2441 at a portion thereof corresponding to the bridging wire latching section 2440a as illustrated in FIG. 6. The bridging wire 2421 (see FIG. 8) is to be latched at the gap generated between the bridging wire latching section 2440a and the notched portion 2442.

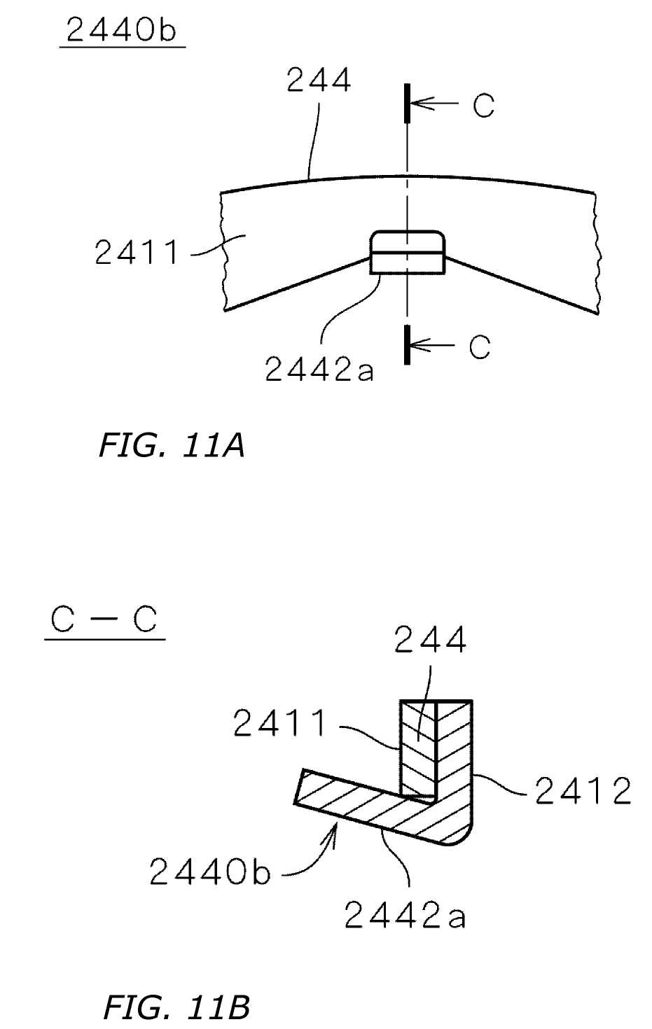

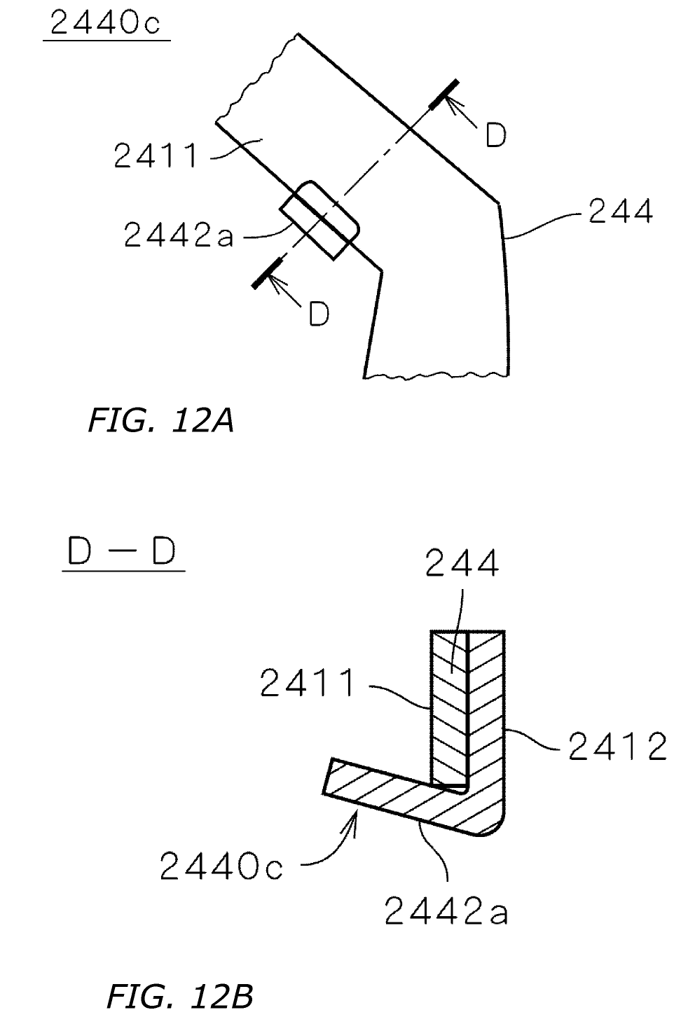

FIG. 11A is an enlarged view of the bridging wire latching section 2440b. FIG. 11B is a diagram illustrating a cross section of the bridging wire latching section 2440b as viewed from a point C-C illustrated in FIG. 11A. Also, FIG. 12A is an enlarged view of the bridging wire latching section 2440C. FIG. 12B is a diagram illustrating a cross section of the bridging wire latching section 2440C as viewed from a point D-D illustrated in FIG. 12A.

The bridging wire latching section 2440b is provided between two adjacent teeth 243b of the second teeth 243b as illustrated in FIG. 9. The bridging wire latching section 2440c is provided between the teeth 243a of the first teeth 243a and between the teeth 243b of the second teeth 243c.

As illustrated in FIGS. 11A and 12B, in the first core plate 2411, the notched portion will not be formed at portion thereof corresponding to the bridging wire latching sections 2440b and 2440c. The protruding portion 2442a in the second core plate 2412 is bent along the inner periphery of the core back 244 thereby forming the bridging wire latching sections 2440b and 2440c.

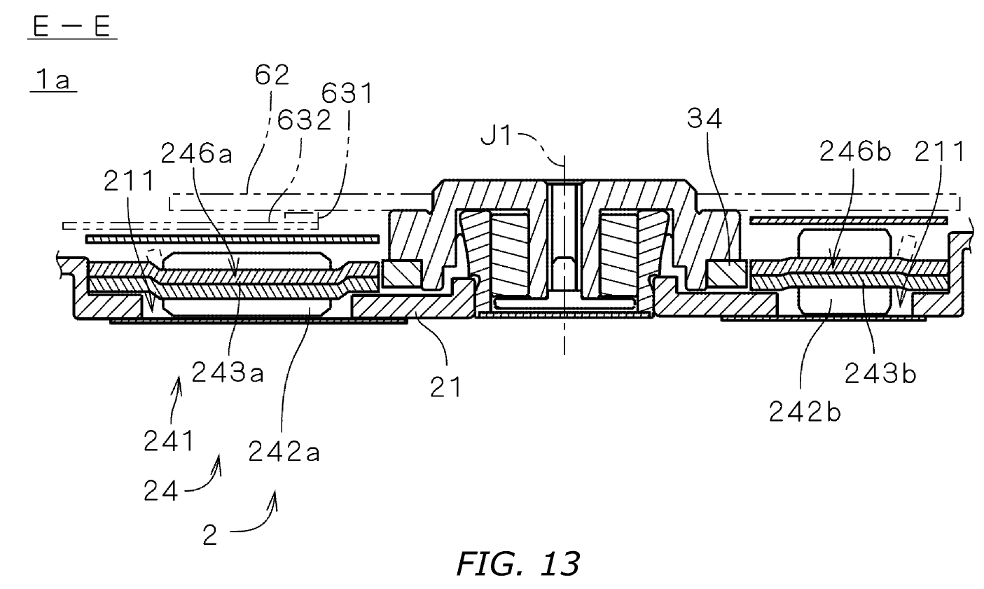

FIG. 13 is a diagram illustrating a cross section of the motor la as viewed from a point E-E illustrated in FIG. 9. As illustrated in FIG. 13, while the stator 24 remains attached to the base plate 21, a lower portion of each of the first coils 242a formed on the first teeth 243a and the second coils 243b formed on the second teeth 243b does not protrude from a bottom surface of the base plate 21. Such portion remains contained above the level of the base plate 21, namely contained within through-hole portions 211. By virtue of the configuration described above, the thickness of the motor la will be reduced without forcing the base plate 21 to be excessively thin.

As illustrated in FIG. 9, in the core 241, tip portions of the tooth 243a and 243beach are arranged in a radial manner such that they surround the center axis J1 while maintaining an equal distance between each tip portion. Also, a distance between the center axis J1 and each tip portion of the teeth 243a and 243b is to be substantially equal. As illustrated in FIG. 13, each tip portion of the teeth 243a and 243b are arranged such that they face an external surface of the rotor magnet 34, thereby effectively generating between the stator 24 and the rotor magnet 34 a torque.

In the stator 24, a wire winding portion 246a of the first teeth 243a around which the wire is wound (hereinafter, referred to as a first wire winding portion 246a) is downwardly bent at a radially middle portion of the first teeth 243a. The distance between the upper surface of the first wire winding portion 246a and an area where the recording disc 62 will be placed (illustrated in FIG. 13 by chain double-dashed line) is greater than the distance between upper surface of the tip portion of the first teeth 243a (and the second teeth 243b) and the area where the recording disc 62 is to be placed.

Further, a portion of the second teeth 243b around which the wire is wound (hereinafter, referred to as a second wire winding portion 246b) is upwardly bent at a radially middle portion of the second teeth 243b. The distance between the upper surface of the second wire winding portion 246b and an area where the recording disc 62 is to be placed is smaller than the distance between an upper surface of the tip portion of the second teeth 243b (and the first teeth 243a) and the area where the recording disc 62 is to be placed.

As illustrated in FIG. 13, the length of the first wire winding portion 246a, along the first-teeth 243a-extending direction is longer than the length of the second wire winding portion 246b, along the second-teeth 243b-extending direction. More preferably, the length of the first wire winding portion 246a is between 1.3 to 4 times longer than the length of the second wire winding portion 246b.

In the stator 24, the maximum accumulated height of the wire (wire winding height) wound around the first wire winding portion 246a of the teeth 243a (i.e., the maximum thickness of the first coil 242a at the upper or lower side of the first teeth 243a) is smaller than the maximum accumulated height of the wire wound around the second wire winding portion 246b of the second teeth 243b.

The winding number of the wire around the first teeth 243a is same to the winding number of the wire around the second teeth 243b. The winding number (i.e., a number of turns the wire winds around the tooth) of the wire around the first teeth 243a and the second teeth 243b is between 30 to 120 (preferably, from 60 to 100). In this embodiment, the number of turns is 80.

In the manufacturing of the stator 24, the wire winding machine 91 is fine tuned so as to precisely wind the wire around each tooth without single turn error. However, even if the program glitch of the wire winding machine 91 makes the number of turns varied among the first teeth 243a and the second teeth 243b, the magnetic property of the stator 24 does not change dramatically as long as the number-of-turn difference is less than 3% of total number of turns of each tooth. Therefore, the number of turns may be recognized substantially same among the teeth of the stator 24.

Further, the bridging wire latching sections 2440a do not protrude toward the center axis J1 since the distance between the bridging wire latching section 2440a and the center axis J1 is greater than the distance between the base of the first tooth 243a and the center axis J1. By this, the needle of the wire winding machine 91 is allowed to move in a large space between the first teeth 243a.

The first coil 242a is arranged so as to adjoin the head portion at the lower side of the head portion (i.e., the head 631 and the arm 632 illustrated by chain double-dash lines in FIG. 13) whose upper end surface is adjacent to the recording disc 62. The second coil 242b is arranged such that the upper end surface thereof adjoins the lower surface of the recording disc 62.

The manufacture method of the stator 24 is the same as that described above with reference to FIG. 7. The core plate is formed by piercing the silicon steel plate (or other electromagnetic steel plate) into the predetermined shape, by pressing the core plate, and by portions of the core plate which will become the bridging wire latching sections 2440 being bent. Then, such core plate is laminated to another core plate so as to form the core 241. Then, the wire is wound by the wire winding machine 91 for the predetermined number of turns around the wire winding portion 246a of the first teeth 243a and around the second wire winding portion 246b of the second teeth 243b. After the wires are wound, the fairing process may be carried out to fair the coil if needed. Then, the wires from the first coil 242a and the second coil 242b are joined with solder to the circuit board 248 (see FIG. 8) and the manufacturing of the stator 24 is completed.

As described above, in the stator 24 of the motor la, the wire winding height generated at the second wire winding portion 246b of the second teeth 243b is greater than the wire winding height generated at the first wire winding portion 246a of the first teeth 243a over which the head portion moves.

Therefore, when there is enough space over the stator 24 in the axial direction to provide the bridging wire latching sections 2440b and 2440c the notched potion 2441 will not be necessary. On the other hand, when there is not enough space over the stator 24 in the axial direction due to the moving area of the head portion, the bridging wire latching section 2440a, whose height is smaller than those of the bridging wire latching sections 2440b and 2440c, is to be provided. Also, the position of the stator 24 can be modified in accordance with a design of the motor. Therefore, the thickness of the stator 24 can be reduced thereby reducing the thickness of the motor la and minimizing the recording disc driving device 60.

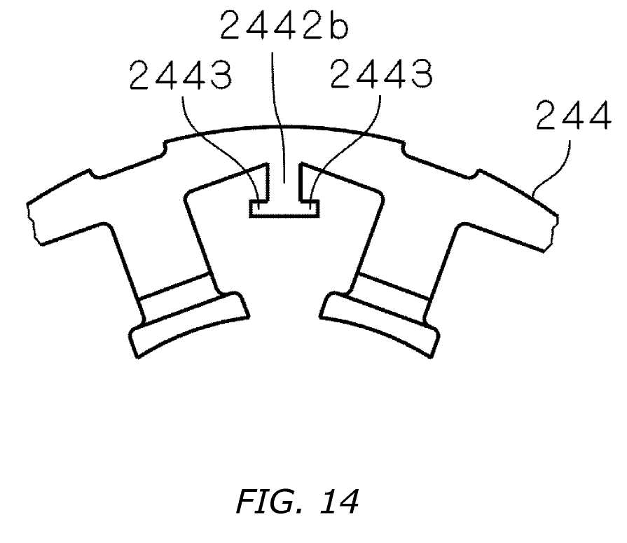

In the second core plate 2412, the protruding portion 2442 does not necessarily need to have the rectangle shape. As illustrated in FIG. 14, for example, the protruding portion 2442b may have a T-shape in which at the tip of the protruding portion 2442b is stretched at both ends in the radial direction with the center axis J1 being the center. The tip of the protruding portion 2442b may only be stretched at one end in the radial direction so as to form an L-shape. When the bridging wire latching section 2443 which is formed by bending the protruding portion 2442b has either the T-shape or the L-shape, the bridging wire latching section will be able to latch the bridging wire 2421 even when a pressure is applied to the bridging wire 2421 such that the bridging wire 2421 is pulled toward the periphery of the core back 244.

In the stator 24 according to the second embodiment, the bridging wire latching section 2440a will be provided only at the portion over which the head portion moves. However, the bridging wire latching section 2440a may be provided at a portion, between adjacent teeth, over which the head portion does not move. By virtue of the configuration described above, the thickness of the motor 1 a can be reduced when, for example, the stator 24 is positioned so as not to make contact with electronic components on the circuit board 248.

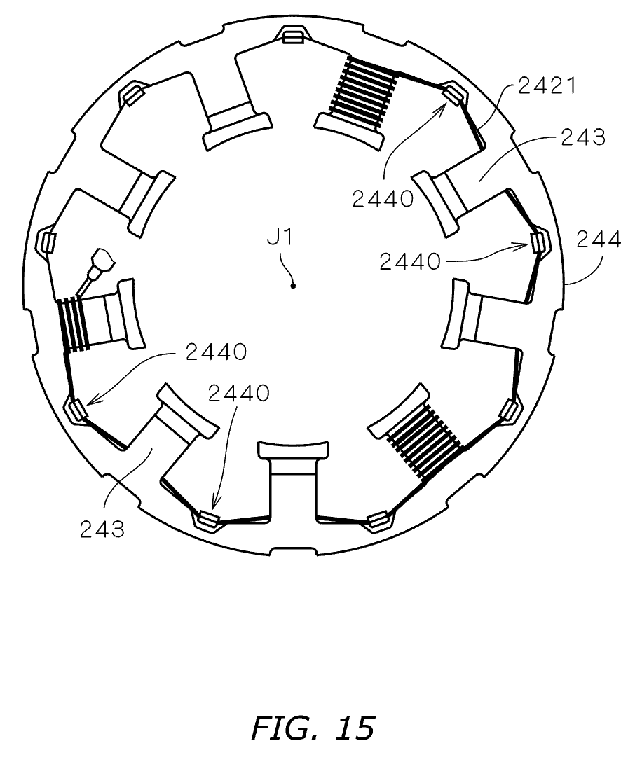

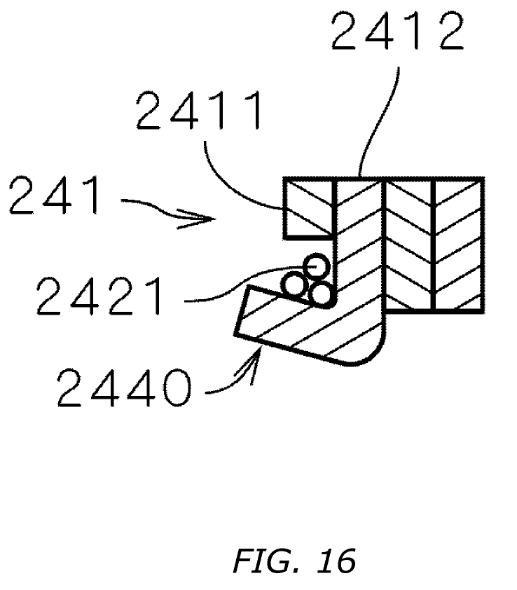

As illustrated in FIG. 15, the bridging wire 2421 can be tucked underneath the teeth 243 between the adjacent bridging wire latching sections 2440. By this, the bridging wire 2421 will be pulled, at both ends in the radial direction, in a downward direction to the lower portion of the core back 244 thereby applying tension to the bridging wire 2421 so as to prevent the bridging wire 2421 from falling off the bridging wire latching section 2440.

Further, when more than two core plates are used to form the core 241, the bridging wire latching section 2440 is to be provided on the second core plate 2412 which makes contact with the first core plate 2411 having the upper surface of the core 241 so that there will be sufficient space, which is needed to contain therein the bridging wire latching section 2440, near the upper surface of the core 241. By this, the bridging wire will easily be latched by the bridging wire latching section 2440.

The bearing mechanism of the motor according to the embodiment of the present invention described above may apply a gas dynamic bearing in which air serves as the working fluid. The bearing mechanism of the motor according to the embodiment of the present invention is not required to apply a hydrodynamic pressure. The bearing mechanism may be a ball bearing.

The motor according to the above described embodiment of the present invention may be used for a purpose other than a use in a hard disc drive. The motor according to the above described embodiment of the present invention may be used as a drive source for a disc driving device for a removable disc device, or the like.

While the invention has been described in detail, the foregoing description is in all aspects illustrative and not restrictive. It is understood that numerous other modifications and variations can be devised without departing from the scope of the invention.

What is claimed is:

1. A stator for a motor used for driving a recording disc, the stator comprising:
a core including thereon a plurality of teeth radially arranged around a center axis with tip portions thereof being toward the center axis, and a ring shaped core back to which the plurality of teeth being connected at the radially outer portions thereof; and
a plurality of coils formed by winding a wire around each of the plurality of teeth, wherein:
the core includes a first core plate and a second core plate which is axially laminated to a bottom face of the first core plate;
the core back and the plurality of teeth include a portion of the first core plate and a portion of the second core plate;
the second core plate includes, at a portion thereof between two adjacent teeth and an inner periphery of the core back, a bridging wire latching section which is a portion of the second core plate bent and protruding toward the first core plate;
a gap is provided between a radially outer face of the latching section and a radially inner edge of the core back; and
at least a portion of the bridging wire connecting two of the plurality of coils passes through the gap.

2. The stator according to claim 1, wherein a core plate which is positioned axially above the second core plate includes at a portion thereof corresponding to the bridging wire latching section of the second core plate a notched portion.

3. The stator according to claim 2, wherein a distance between the bridging wire latching section and the center axis is greater than a distance between an outer end of the coil and the center axis.

4. The stator according to claim 2, wherein the bridging wire latching section is provided on the core back at the portion between every two adjacent teeth.

5. The stator according to claim 1, wherein a distance between the bridging wire latching section and the center axis is greater than a distance between an outer end of the coil and the center axis.

6. The stator according to claim 1, wherein the bridging wire latching section is provided on the core back at the portion between every two adjacent teeth.

7. The stator according to claim 1, wherein:
the teeth comprise a plurality of first teeth and a plurality of second teeth, wherein coils wound around each of the first teeth having longer length than those wound around any one of the second teeth in a radial direction; and
the first teeth are arranged in a series in a circumferential direction.

8. The stator according to claim 1, wherein:
the teeth comprise a plurality of first teeth and a plurality of second teeth, wherein a length of any one of the first teeth is longer than that of any one of the second teeth; and
the first teeth are arranged in a series in a circumferential direction.

9. The stator according to claim 1, wherein a thickness of the core is less than 0.5 mm.

10. The stator according to claim 1, wherein the core is comprised of three or more core plates.

11. An electric motor, comprising:
a stationary portion including the stator according to claim 1 and a base portion retaining the stator;
a rotor portion including a rotor magnet generating between the rotor magnet and the stator a torque centering around a center axis; and
a bearing mechanism rotatably supporting the rotor portion relative to the stationary portion with the center axis as a center.

12. A recording disc driving device having a recording disc for recording therein data, the device comprising:
the motor according to claim 11 for rotating the recording disc;
a head portion for reading data from and writing data on the recording disc; and
a head locating member for moving the head portion relative to the recording disc and the motor.
